(19) United States
(12) Patent Application Publication
(10) Pub. No.: US 2021/0299848 A1
(43) Pub. Date: Sep. 30, 2021

(54) BALANCER FOR TOOLS

(71) Applicant: TECNA S.P.A., Castel San Pietro Terme (IT)

(72) Inventors: Damiano BERGAMI, Castel Guelfo di Bologna (IT); Andrea LOLLI, Budrio (IT); Fabio GUBELLINI, Imola (IT)

(21) Appl. No.: 17/265,362

(22) PCT Filed: Aug. 3, 2018
(86) PCT No.: PCT/IT2018/000104

§ 371 Date: Feb. 2, 2021

(51) Int. Cl. B25H 1/00; B66D 3/20; B66D 3/26; B66D 1/40; B66D 5/16

(52) U.S. Cl. CPC B25H 1/0028; B66D 3/20; B66D 5/16; B66D 1/40; B66D 3/26

(57) ABSTRACT

A balancer for tools includes a rotating winding and unwinding drum for a cable, configured with a free end for supporting a tool. The balancer also includes a spring, wound around the main axis of rotation of the drum and integral with a terminal portion with the drum, in order to generate an elastic reaction, as a consequence of the unwinding of the cable and of the consequent rotation of the drum, adapted to facilitate the rewinding of the cable. The balancer further includes an element for braking the drum, which is adapted to generate a resisting moment which acts even indirectly on the drum to contrast the rewinding stroke of the cable; a respective electronic unit is furthermore associated with the element and is provided with a module for the control and adjustment of the intensity of the resisting moment generated by the element.

### TECHNICAL FIELD

The present disclosure relates to a balancer for tools.

### BACKGROUND

As is known, in the prior art (and therefore in the present description), the term “balancer” refers to a device used in workshops and production departments in order to facilitate the task of an operator assigned to perform a process by using a tool.

In greater detail, according to methods that are by now well-established, the balancer comprises a rotatable drum which hangs from the ceiling and around which a cable is wound; the cable is fixed at one end to said drum and has, at the opposite end, a hook to which the tool can be coupled at least temporarily.

The balancer further has a return spring, typically a spiral spring, which is coupled with one of its ends to the drum and is normally preloaded. When the operator pulls the hook toward himself, he causes the unwinding of the cable and the consequent rotation of the drum; this obviously deforms the spring and causes the onset of a further elastic constraining reaction.

In some applications, the task of the device, and of the reaction of the spring in particular, is to balance the weight of the tool that hangs from the hook, keeping it at the desired vertical height and allowing the operator to handle it without effort. In other cases, the balancer has the additional task of keeping the tool in a dedicated receptacle, from which the operator can remove it when needed (causing the unwinding of the hook that supports said tool). In this case, the reaction of the spring has the task of returning the tool and the hook to the receptacle as soon as it is released by the operator at the end of use.

However, a drawback often occurs in all these contexts.

The force generated by the spring depends on the initial preloading and on the further elastic reaction produced by the deformation caused by the unwinding of the hook. Not infrequently, this force is very strong and therefore the rewinding (the rise) of the hook occurs far too quickly, with the mass of the latter (and possibly of the tool) that acquires speed rapidly and strikes violently the casing of the balancer that hangs from the ceiling and accommodates the drum. Furthermore, due to inertia, the end part of the cable bends in a cyclic manner, deteriorating progressively.

Obviously, these are in any case unwelcome events, which can lead to damage of the balancer and/or failures of the cable (with the fall of the applied load).

### SUMMARY

The aim of the present disclosure is to solve the problems described above, by providing a balancer for tools that allows optimum rewinding of the cable, avoiding violent impacts and damage.

Within this aim, the disclosure provides a balancer that offers the possibility to slow the rewinding stroke in manners that can be adjusted at will.

The disclosure also provides a balancer that ensures optimum rewinding of the cable, with a solution that can be implemented effectively on any type of drum.

The disclosure further provides a balancer in which the cable is slowed down only in the final portion of its rewinding stroke.

The disclosure also provides a balancer that offers the possibility to gather and transmit data and information regarding its operation.

The disclosure further provides a balancer that ensures high reliability in operation and is powered autonomously.

The disclosure provides a balancer that adopts a technical and structural architecture that is alternative to those of balancers of the known type.

The disclosure provides a balancer that can be obtained easily starting from commonly commercially available elements and materials.

The disclosure further provides a balancer that has modest costs and is safe in application.

This aim and these and other advantages which will become better apparent hereinafter are achieved by a balancer according to the independent claim.

### BRIEF DESCRIPTION OF THE DRAWINGS

Further characteristics and advantages of the disclosure will become better apparent from the description of a preferred but not exclusive embodiment of the balancer according to the disclosure, illustrated by way of non-limiting example in the accompanying drawings, wherein:

FIG. 1 is a perspective view of the balancer according to the disclosure, without some components;

FIG. 2 is a front elevation view of the balancer according to the disclosure, with part of the covering removed, in order to show the interior;

FIG. 3 is a sectional view, taken along an axial plane that is perpendicular to the ground, of the balancer according to the disclosure;

FIG. 4 is a schematic partially exploded perspective view of some components of the balancer;

FIG. 5 is a schematic perspective view, taken from another angle, of the components of FIG. 4;

FIG. 6 is a schematic perspective view of some components of the balancer, including the braking element;

FIG. 7 is a schematic perspective view of an external component of the balancer; and

FIG. 8 is a perspective view of the balancer, with the covering partially removed, and of an additional device with which it can interact.

### DETAILED DESCRIPTION OF THE DRAWINGS

With reference to the figures, the reference numeral 1 generally designates a balancer for tools, i.e., an apparatus that can be used to offer valid assistance to operators who must perform tasks of various kinds by using indeed a tool of various kinds.

The balancer 1 therefore comprises a rotating winding and unwinding drum 2 for a cable 3, which is fixed or in any case coupled to the drum 2 with a first end.

The cable 3 is configured, with one free end 3a thereof (opposite the first end), to support a tool (of various kinds, shape, weight and intended use). For example, support can occur by fixing a spring-clip 4 (or another type of hook) to the free end 3a, so as to allow the operator to provide a stable but at the same time easily removable coupling indeed between the cable 3 and the tool.

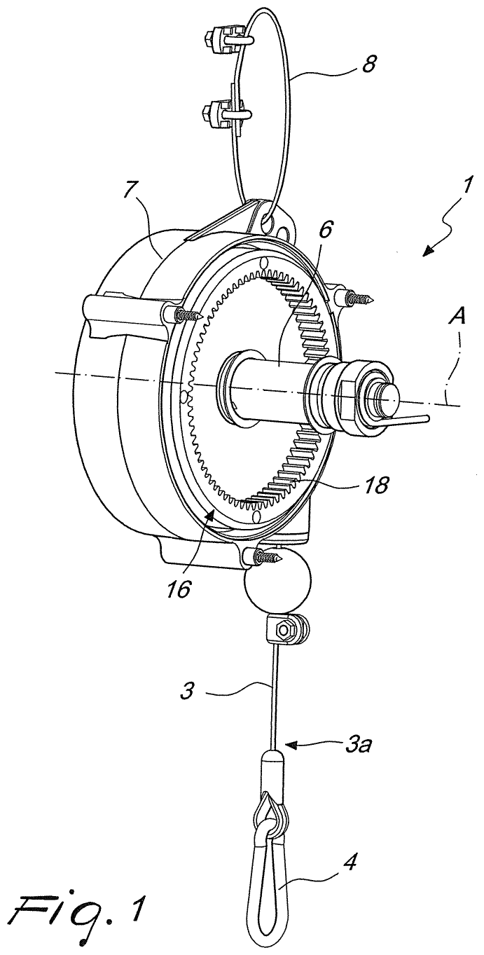

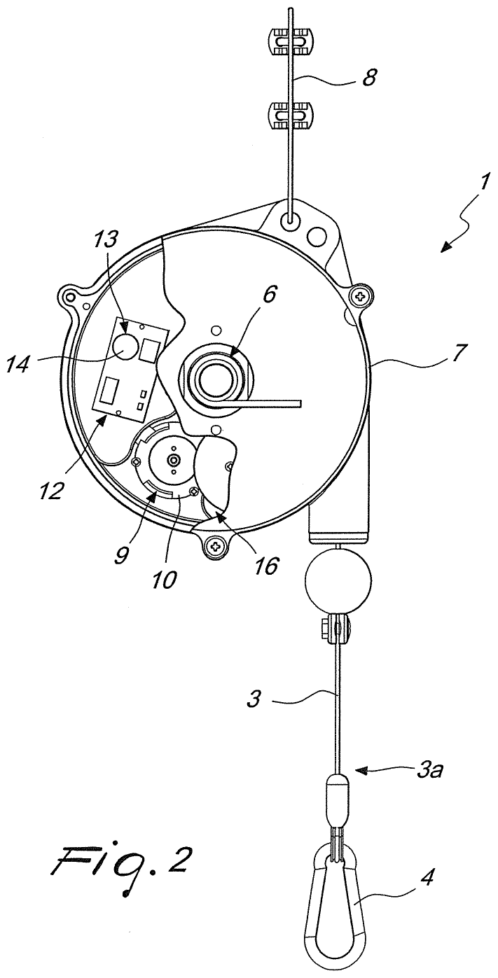

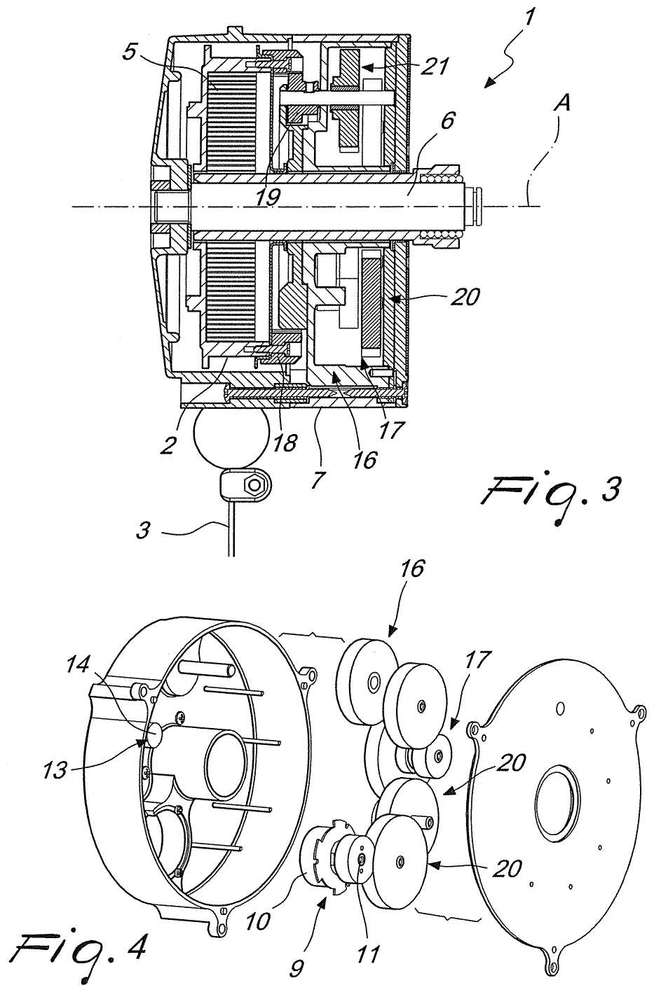

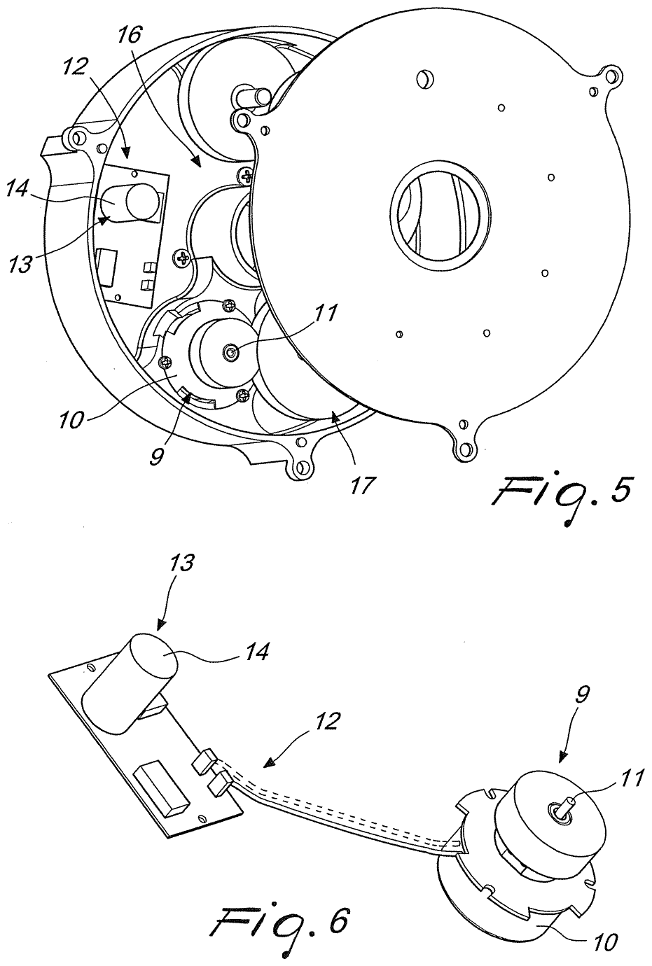

The balancer 1 further comprises a spring 5 which is wound around the main axis of rotation A of the drum 2 (for the sake of simplicity, the main axis A is shown only in FIGS. 1 and 3). The spring 5 is normally (but not necessarily) preloaded and is typically of the spiral type (although other constructive solutions are not excluded); it is in any case integral, with a terminal portion, with the drum 2, so as to produce an elastic reaction, as a consequence of the unwinding of the cable 3 and of the consequent rotation of the drum 2, said reaction being adapted to facilitate the rewinding of said cable 3. At the opposite end, the spring 5 is normally coupled to a fixed component of the balancer 1.

In various manners, and as a function of the specific application and of the use of the balancer 1, rewinding typically occurs in any case at the end of the use of the tool.

The drum 2, preferably mounted on a shaft 6 which is extended along (and forms) the main axis A, can have a cylindrical shape (as in the solution of the accompanying figures) or a conical/frustum-like shape, or another shape, without thereby abandoning the protective scope claimed herein. As will become apparent, one of the particularities of the disclosure is indeed that it can be implemented equally on drums 2 of different shapes, ensuring maximum versatility and a wide range of application.

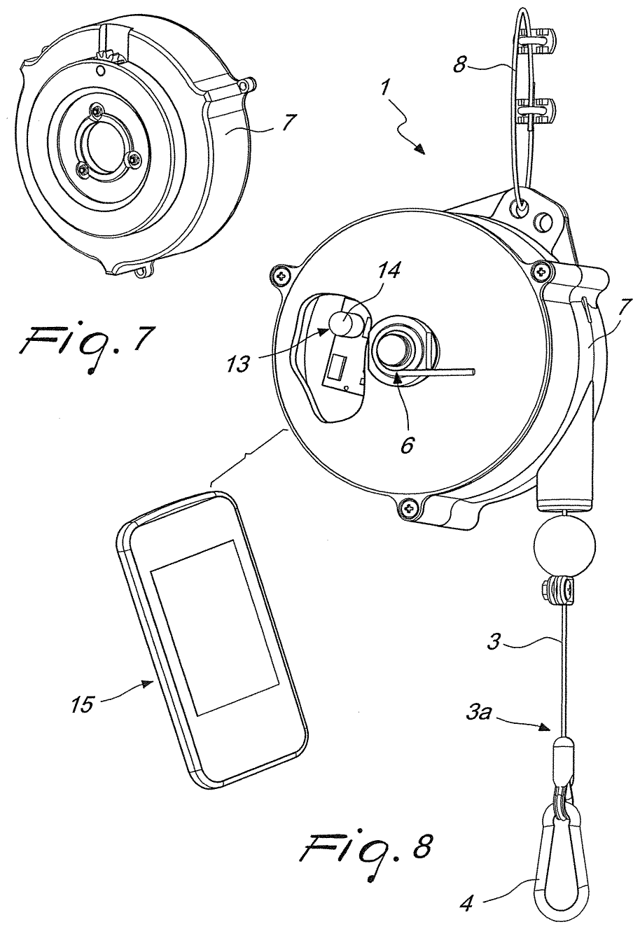

It should be noted, furthermore, that typically the drum 2 is enclosed by a casing 7 (subject matter of FIG. 7), which is open downward in order to allow the winding and unwinding of the cable 3; the casing 7, which is fixed, accommodates rotatably the drum 2 and is provided in an upward region with a hook, loop 8 or other support accessory in order to be able to hang it from the ceiling or from another wall.

So far, the balancer 1 is of the traditional type, and can also be provided with additional components and devices of a known type, in order to give it other useful functionalities, such as for example a system for adjusting the preloading of the spring 5.

According to the disclosure, the balancer 1 comprises an element 9 for braking the drum 2, which is adapted to generate a resisting moment which acts directly or indirectly on the drum 2, in order to contrast the rewinding stroke of the cable 3 (which, as mentioned, is coupled to the drum 2 with a first end thereof). The resisting moment can thus slow and brake the rising stroke.

A respective electronic unit is further associated with the element 9 and is provided with a module for controlling and adjusting the intensity of the resisting moment generated by said element 9.

The electronic unit can be of any type, and for example it can be an electronic controller mounted on board the balancer 1; it is not excluded, in any case, to resort to different types of electronic unit (mounted or not inside the casing 7), which might thus be any hardware platform, reprogrammable or not, in any case capable of acting (automatically and/or as a consequence of the intervention of a user) on the intensity of the resisting moment.

This allows to achieve already at this point the intended aim, since the element 9 allows to slow the rewinding stroke, avoiding the danger of violent impacts against the casing 7 and/or damage of the cable 3. Furthermore, the electronic unit offers the possibility to adjust the intensity of the resisting moment and therefore to modulate at will, according to different speed ramps, said rewinding stroke, so as to adapt it to the specific requirements and in any case obtaining an optimum behavior.

In particular, in the preferred embodiment, shown in the accompanying figures by way of non-limiting example of the application of the disclosure, the element 9 is an electric motor 10, which is connected even indirectly, with its rotor 11, to the drum 2. The resisting moment generated by the element 9 is therefore, in the preferred embodiment, constituted by the mechanical moment generated by the electric motor 10, which acts as a brake (for this type of application, the mechanical moment can also be termed “braking torque” used in the art).

It is specified that the electric motor 10 can be of any type, without thereby abandoning the protective scope claimed herein, which in any case includes the possibility to resort to other elements 9.

Usefully, the balancer 1 comprises a circuit 12 for the electric power supply of the motor 10, which comprises a power source 13 and an electrical switching device, which is interposed between the source 13 and the motor 10 and controlled by the electronic unit. By acting on the switching device it is thus possible to adjust the intensity of the mechanical moment and/or, more generically, adjust the operating parameters of the motor 10. Within the same rising stroke it is in fact possible to interrupt the power supply any number of times, for time intervals the duration of which is in turn chosen at will.

The possibility is in any case provided to control in another manner the motor 10 and the resisting moment, by acting in different manners on the intensity of the current supplied to the motor 10 (by varying the resistance of the circuit 12, for example, or by acting directly on the source 13) even by modifying other parameters of the circuit 12 by means of the electronic unit.

More particularly, the source 13 is constituted by a capacitor 14 (although it should be specified that other constructive choices are not excluded).

The capacitor 14 is configured to accumulate electric power during at least one first recharging step of the rotation of the drum 2 and to deliver current to the motor 10 during at least one second braking step of the rotation of the drum 2.

By virtue of this particular practical solution, the delivery of current to the motor 10 does not require connection to the mains or other external delivery methods, nor is depletion of the energy available to be feared (as might occur by arranging batteries in the balancer 1).

In fact, said first recharging step can coincide with the unwinding stroke of the cable 3 and/or with part of the rewinding stroke (the one in which one does not wish to brake the drum 2): in this circumstance, the drum 2 in fact rotates under the action of the operator who unwinds the cable 3 or by virtue of the elastic reaction of the spring 5 and by means of an appropriate conversion system the mechanical energy is converted into electric power, which the capacitor 14 can accumulate.

When instead one wishes to brake the drum 2, the capacitor 14 releases part of the energy previously accumulated to activate the motor 10.

Moreover, the capacitor 14 can take on the task of supplying power also to the electronic unit and to any other electrical/electronic component mounted on the balancer 1, making the latter autonomous at the energy level and avoiding the need to supply it with power through an external source.

Advantageously, the balancer 1 comprises a user interface for controlling the control and adjustment module (and/or, more generally, the electronic unit), in order to allow a user to selectively vary the intensity of the resisting moment generated by the element 9.

The user can act manually in order to set in various manners the rising stroke, for example by activating or deactivating the electrical switching device or by giving him the option to choose among different preset speed ramps, which are programmed beforehand and/or optionally can be (re)programmed.

It is not excluded in any case to provide balancers 1 according to the disclosure in which the possibility to act on the electronic unit is limited (to one person in charge or to a few persons in charge) or is inhibited, in order to prevent abuses or in any case unwanted and potentially harmful uses.

In particular, in one possible embodiment, the interface comprises a display, which is kept accessible from the outside (for example because it is mounted on the casing 7 which covers and protects the drum 2).

Conveniently, the electronic unit comprises an NFC communication module which is associated with the control and adjustment module (it is not excluded in any case to resort to different contactless data exchange technologies). This allows the remote control of the element 9, even by means of a mobile device 15 (obviously provided with NFC functions), such as a mobile phone, a smartphone, a tablet, or the like.

By means of the mobile device 15 (and an optional software application preset for this purpose) it is possible for example to make available to the operator (or to the persons in charge) the same functions of the display (whether provided or not), in practice rendering the mobile device 15 a further (or alternative) user interface and increasing the practicality of use of the disclosure.

Positively, the electronic unit is provided with a module for gathering data related to the rotation of the drum 2 and/or to the unwinding and rewinding cycles of the cable 3. These data can be obtained by placing sensors aimed at detecting the linear position and/or speed and/or acceleration parameters of the cable 3 and/or the angular parameters of the drum 2.

It should be noted that by monitoring and preserving the information related to the rotation of the drum 2 (to its angular position and/or its speed, for example) and/or to the unwinding and rewinding cycles of the cable 3 it is possible to obtain information on the wear/deterioration conditions of the balancer 1 and in general on reliability. It is in fact possible to know at all times when and how the balancer 1 operated during its useful life, subsequently correlating these data with failures and maintenance operations. This allows first of all to obtain information and indications regarding the reasons that can have caused a malfunction of the specific balancer 1; furthermore, by mutually correlating the data that arrive from different balancers 1 it is possible to deduce significant indications regarding the expected average life, in order to schedule preventive maintenance and interventions, for example.

The methods for extracting the acquired information from the data gathering module may be any according to the specific requirements.

Favorably, the electronic unit can comprise at least one transceiver module, associated with the data gathering module and configured to establish a communication with a remote data bank and/or a remote electronic processing control unit, at least for the remote sending of the data acquired by the gathering module (and indeed perform the analyses briefly described in the preceding paragraphs).

The transceiver module 16 can be chosen of a known type and can be preferably but not exclusively capable of establishing a connection to the Internet (and/or to the mobile device 15), in order to transmit the data remotely indeed via the Internet. The remote data bank and the remote electronic control unit can be for example located at (or in any case managed by) the manufacturer of the balancer 1, so that the latter can indeed accumulate data regarding a plurality of balancers 1 installed in different contexts, obtain statistical data and formulate predictive hypotheses on the lifespan and reliability of the components, in order to study in the best possible manner preventive maintenance programs and/or adopt the necessary countermeasures in order to prolong the life of said balancers 1. It is not excluded to provide the possibility to remotely program the balancer 1 and the electronic unit in particular by means of the transceiver module 16.

In one embodiment of considerable practical interest, the control and adjustment module is provided with instructions for the automatic activation of the braking element 9 only at a terminal portion of the rewinding stroke of the cable 3 (i.e., when the free end 3a is by then close to the drum 2 and to the casing 7, which typically hang from the ceiling).

This is of unquestionable practical interest, since without compromising the function of safeguarding and prevention of the balancer 1 from damage caused by impacts with the tool and/or the spring-clip 4, it allows to reduce the overall ascent time and therefore the wait before rewinding is completed (where necessary), since indeed the element 9 brakes the drum 2 and the cable 3 only for a small fraction of the stroke, while for the remaining part the speed is left maximum.

The terminal portion of interest, and the moment when it is reached at each stroke, can be determined by means of a respective preliminary calibration module. The calibration module, in fact, by communicating for example with the data gathering module and/or with the control and adjustment module, can be preset to cause the execution of a first full winding and unwinding stroke (optionally issuing, by means of the interface, a request in this regard at first power-on).

Thus, the electronic unit can store the information related to the maximum extension of the cable 3 and in general to the maximum stroke of the components, to then combine this data item in each instance with the position of the cable 3 and of the free end 3a at each instant (which can be obtained for example with the cited sensors). It is not excluded to provide the operator or the person in charge with the possibility to modify (optionally within certain preset parameters) the extent of the end portion in order to adapt it to the specific requirements.

Usefully, in the preferred embodiment, which in any case does not limit the application of the disclosure, the element 9 (be it the electric motor 10 or other) is connected to the drum 2 by virtue of motion transmission means 16, which comprise a speed multiplier assembly 17, which is interposed between the drum 2 and said element 9.

If the element 9 is an electric motor 10, the transmission means 16 establish a mechanical connection between the drum 2 and the rotor 11.

In particular, the means 16 comprise a ring gear 18, which is mounted in a coaxially integral manner on the drum 2 and meshes with a pinion 19 (FIG. 3), the latter being associated with the element 9 by means of said assembly 17, which in turn comprises gear transmission elements 20 (FIGS. 3 and 4) arranged functionally in series.

Usefully, the balancer 1 according to the disclosure comprises an element 21 (FIG. 3) for inhibiting the transmission means 16, which is first of all kept automatically active during a rotation of the drum 2 in a first direction, which corresponds to the unwinding of the cable 3. In this manner, the element 9 is not functionally and mechanically connected to the drum 2, and this evidently prevents the cable 3 from being braked when it descends, moving away from the drum 2 with its free end 3a, pulled by an operator.

Vice versa, the inhibition element 21 is automatically inactive during a rotation of the drum 2 in a second direction, which is opposite with respect to the first direction and corresponds to the rewinding of the cable 3. This evidently restores the connection between the element 9 and the drum 2 and allows the former to operate according to what has already been shown, transmitting if necessary the resisting moment to the drum 2 and braking it.

It should be noted that in the preferred embodiment of the balancer 1 according to the disclosure, which indeed provides for the presence of the inhibition element 21, during the unwinding of the cable 3 the capacitor 14 and the motor 10 are disconnected from the drum 2 and therefore the recharging of the capacitor 14 can occur only during part of the ascent/rewinding stroke (but indeed not during the unwinding stroke). In other embodiments, which are in any case within the protective scope claimed herein, which for example do not provide for the inhibition element 21, it is possible to recharge the capacitor 14 also during the descent/unwinding stroke.

In particular, in the preferred embodiment, which is in any case not exclusive, the inhibition element 21 is constituted by a free wheel, which is associated with one of the transmission elements 20.

As is known, the free wheel is a mechanical device which allows indeed to uncouple the rotating components between which it is interposed, when the rotation occurs in one of the two directions, allowing it only in the other direction (as indeed required in this case).

Even more particularly, in the preferred embodiment the pinion 19 constitutes a component of the free wheel.

The operation of the balancer according to the disclosure is as follows.

In manners that are already are per se known, and for example by means of the hook 7, the balancer 1 can be hung from the ceiling (or from a wall) in order to facilitate the task of an operator, who can in fact use a tool keeping it coupled to the spring-clip 4.

During the execution of the activity, the elastic reaction of the spring 5 can compensate the weight of the tool, indeed facilitating the task of the operator. The elastic reaction of the spring 5 can furthermore cause the rewinding of the cable 3 at the end of the activity.

In any case, as shown, the element 9 generates a resisting moment during all or (preferably) part of the ascent stroke of the cable 3, ensuring optimum rewinding thereof and avoiding violent impacts and damage, which otherwise are possible due to the potentially high speed and acceleration caused by the extent of the elastic reaction of the spring 5.

Furthermore, the braking intensity and therefore the speed ramp of the cable 3 during rewinding can be controlled and adjusted effectively at will by the electronic unit (and/or by an operator), who can intervene in various manners on the electric motor 10 (or other element 9) and on the resisting moment generated by the latter.

For example, in fact, the electronic unit can control the electric switching device interposed between the motor 10 and the capacitor 14 that delivers current thereto. By allowing and denying the passage of current, according to preset time intervals, it is possible to cause current to circulate in the motor 10 according to the desired profile, correspondingly generating a behavior at will of the resisting moment.

It should be noted that by varying the choice of the electric motor 10 and/or of the components of the power supply circuit 12 it is furthermore possible to modify at will the resisting moment generated in the absence of current, being able to decide that in this condition it produces or not a braking action of any intensity (even such as to completely prevent ascent).

In any case, it should be noted that the solution described so far does not provide for any specific requirement of a geometric/structural kind of the drum 2 and therefore can be certainly implemented effectively on balancers 1 provided with drums 2 which are conical, frustum-shaped, cylindrical, or otherwise shaped, ensuring maximum versatility to the disclosure.

It has already been observed that the control and adjustment module can be supplied with instructions for the automatic activation of the element 9 only at a terminal portion of the rewinding stroke of the cable 3, causing the latter to be slowed only in the final portion of its rewinding stroke: this allows to contain the ascent time without compromising the particularity of the disclosure (i.e., the possibility to avoid violent impacts against the drum 2 and the casing 7).

The data gathering module and the transceiver module allow respectively to acquire useful information on the operation of the balancer 1 1 and to transfer it even remotely (or even to reprogram remotely the electronic unit and the control and adjustment module in particular).

Finally, it is stated once again that by choosing the capacitor 14 as a power source 13 for the element 9 it is possible to render the balancer 1 independent without having to resort to external or in any case ad hoc power sources.

The disclosure thus conceived is susceptible of numerous modifications and variations, all of which are within the scope of the appended claims; all the details may further be replaced with other technically equivalent elements.

In the exemplary embodiments shown, individual characteristics, given in relation to specific examples, may actually be interchanged with other different characteristics that exist in other exemplary embodiments.

In practice, the materials used, as well as the dimensions, may be any according to the requirements and the state of the art.

1-14. (canceled)

15. A balancer for tools comprising: a rotating winding and unwinding drum for a cable, configured with a free end for supporting a tool, and a spring, wound around a main axis of rotation of said drum and integral with a terminal portion with said drum, in order to generate an elastic reaction, as a consequence of an unwinding of said cable and of a consequent rotation of said drum, adapted to facilitate a rewinding of said cable, further comprising a braking element for braking said drum, which is adapted to generate a resisting moment which acts even indirectly on said drum to contrast a rewinding stroke of said cable, a respective electronic unit being associated with said element and being provided with a module for control and adjustment of an intensity of said resisting moment generated by said element.

16. The balancer according to claim 15, wherein said element is an electric motor that is connected even indirectly, with a rotor to said drum, said resisting moment being constituted by a mechanical moment generated by said motor.

17. The balancer according to claim 16, further comprising a circuit for electric power supply of said motor, which is provided with a power source and with an electrical switching device, said electrical switching device is interposed between said source and said motor and is controlled by said electronic unit, to adjust an intensity of said mechanical moment or adjust operating parameters of said motor.

18. The balancer according to claim 17, wherein said source is constituted by a capacitor, configured to accumulate electric power during at least one first recharging step of a rotation of said drum and to deliver current to said motor during at least one second braking step of the rotation of said drum.

19. The balancer according to claim 15, further comprising a user interface for the control of said control and adjustment module, to allow a user to selectively vary the intensity of said resisting moments generated by said element.

20. The balancer according to claim 19, wherein said interface comprises a display that is kept accessible from outside.

21. The balancer according to claim 15, wherein said electronic unit comprises an NFC communication module associated with said control and adjustment module to allow the remote control of said element, even by a mobile device.

22. The balancer according to claim 15, wherein said electronic unit is provided with a module for gathering data related to the rotation of said drum or to the unwinding and rewinding cycles of said cable.

23. The balancer according to claim 22, wherein said electronic unit comprises at least one transceiver module, which is associated with said data gathering module and is configured to establish a communication with a remote data bank or a remote electronic processing control unit, at least for a remote sending of the data acquired by said gathering module.

24. The balancer according to claim 15, wherein said control and adjustment module is provided with instructions for an automatic activation of said braking element only at an end portion of the rewinding stroke of said cable, which is configured to be determined by a preliminary calibration module.

25. The balancer according to claim 15, wherein said braking element is connected to said drum by virtue of motion transmission means which comprise a speed multiplier assembly interposed between said drum and said element.

26. The balancer according to claim 25, wherein said motion transmission means comprise a ring gear mounted to be coaxially integral on said drum and meshes with a pinion, associated with said element by said multiplier assembly, comprising gear transmission elements which are arranged functionally in series.

27. The balancer according to claim 25, further comprising an inhibition element for inhibiting said motion transmission means, which is automatically active during a rotation of said drum in a first direction and corresponds to the unwinding of said cable, and said inhibition element is automatically inactive during a rotation of said drum in a second direction, which is opposite to said first direction and corresponds to the rewinding of said cable.

28. The balancer according to claim 27, wherein said inhibition element is constituted by a free wheel, said free wheel being associated with one of said transmission elements.
